(19) United States
(12) Patent Application Publication
(10) Pub. No.: US 2013/0278724 A1
(43) Pub. Date: Oct. 24, 2013

(54) METHOD AND APPARATUS FOR RECOGNIZING THREE-DIMENSIONAL OBJECT

(71) Applicant: SAMSUNG ELECTRONICS CO. LTD., Suwon-si (KR)

(72) Inventors: Boram NAMGOONG, Seoul (KR); Suksoon KIM, Suwon-si (KR); Misun LEE, Anyang-si (KR); Donguk CHOI, Hwaseong-si (KR)

(73) Assignee: SAMSUNG ELECTRONICS CO. LTD., Suwon-si (KR)

(21) Appl. No.: 13/738,576

(22) Filed: Jan. 10, 2013

(30) Foreign Application Priority Data
Apr. 24, 2012 (KR) 10-2012-0042811

(51) Int. Cl. G06F 21/31

(52) U.S. Cl. CPC G06F 21/31
USPC 348/46

(57) ABSTRACT

A method and an apparatus for recognizing a three-dimension object using a light source are provided. The method of recognizing a three-dimension object of a terminal including a display unit for displaying an operation state of the terminal and a shoot unit for receiving an image includes receiving a first image by setting a first brightness as a brightness of the display unit, receiving a second image by setting a second brightness as the brightness of the display unit, and recognizing the three-dimension object based on brightness change of a preset part by comparing the second image with the first image. The apparatus and the method for recognizing a three-dimension object prevent a security function from being incapacitated using a two-dimension photograph.

### PRIORITY

This application claims the benefit under 35 U.S.C. §119(a) of a Korean patent application filed on Apr. 24, 2012 in the Korean Intellectual Property Office and assigned Serial No. 10-2012-0042811, the entire disclosure of which is hereby incorporated by reference.

### BACKGROUND OF THE INVENTION

1. Field of the Invention

The present invention relates to an apparatus for recognizing a three-dimensional object. More particularly, the present invention relates to a method and an apparatus for recognizing a three-dimension object using a light source.

2. Description of the Related Art

In recent years, use of a portable terminal, such as a portable tablet Personal Computer (PC), has increased. Accordingly, a request for a security function of the portable terminal has increased. The security function is a function which prevents anyone other than an owner of the portable terminal from using the portable terminal.

According to a password input scheme known in the art, a user may set a password for using the portable terminal. When power of the portable terminal is turned-off and turned-on or when the portable terminal is switched from a sleep mode to an active state, the portable terminal provides a password input screen. If the user properly inputs a preset password, the portable terminal enters a state which allows a user to use a function of the portable terminal, such as a phone call or use of the Internet. Conversely, if the user does not input the password, the portable terminal maintains a lock state. Before inputting a right password, the user cannot use the function of the portable terminal.

In other similar schemes, a scheme using human body information, such as iris recognition, fingerprint recognition, and face recognition schemes may be utilized. The user may previously input fingerprint/iris/face images. Thereafter, when power is turned-off and turned-on or when the portable terminal is switched from a sleep state to an active state, the portable terminal enters a lock state. The user may provide fingerprint/iris/face images to the portable terminal through a camera of the portable terminal or other input means to release the lock state. If the portable terminal receives the same fingerprint/iris/face images as preset images, it may release the lock state.

More particularly, providing a security function using a face image of an image similar to the face is described. Fundamentally, a face image received by the portable terminal is a two-dimensional image. It is assumed that an owner of the portable terminal previously inputs a face of the owner as security means. Thereafter, when the portable terminal enters a lock state, the owner of the portable terminal exposes the face of the owner to a camera of the portable terminal to release the lock state. Conversely, even if a face of a person other than the owner of the portable terminal is exposed to a camera of the portable terminal, the lock state is not released. When a face of the owner of the portable terminal is shot, a photograph is outputted, and the photograph is exposed to the camera of the portable terminal, the portable terminal cannot distinguish a face of an actual person of a three-dimension from a two-dimension photograph. Accordingly, there is a problem that a person other than the owner of the portable terminal may release a lock state of the portable terminal in a scheme of exposing a face photograph to the camera. In general, there is a problem in recognition of a face of the person but there causes the same problem in a scheme of recognizing another three-dimension object.

Therefore, a need exists for an apparatus and a method for recognizing a three-dimension object by preventing a security function from being incapacitated when using a two-dimension photograph.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for recognizing a three-dimension object by preventing a security function from being incapacitated when using a two-dimension photograph, and a method thereof.

In accordance with an aspect of the present invention, a method of recognizing a three-dimension object of a terminal including a display unit for displaying an operation state of the terminal and a shoot unit for receiving an image is provided. The method includes receiving a first image by setting a first brightness as a brightness of the display unit, receiving a second image by setting a second brightness as the brightness of the display unit, and recognizing the three-dimension object based on brightness change of a preset part by comparing the second image with the first image.

In accordance with another aspect of the present invention, an apparatus for recognizing a three-dimension object is provided. The apparatus includes a display unit for displaying an operation state of a terminal, a shooting unit for receiving an image, a controller for controlling the shooting unit to receive a first image by setting first brightness as brightness of the display unit, for controlling the shooting unit to receive a second image by setting second brightness as the brightness of the display unit, and for recognizing the three-dimension object based on brightness change of a preset part by comparing the second image with the first image.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A is a block diagram illustrating a configuration of an apparatus for recognizing a three-dimension object according to an exemplary embodiment of the present invention;

FIG. 1B is a front view of an apparatus for recognizing a three-dimension object according to an exemplary embodiment of the present invention;

FIG. 2 is a flowchart illustrating a method of setting a lock function using a three-dimension object recognition according to a first exemplary embodiment of the present invention;

FIG. 3 is a flowchart illustrating a method of recognizing a three-dimension object according to a first exemplary embodiment of the present invention;

FIGS. 4A through 4C are exemplary diagrams illustrating a shot image of a shooting unit according to a first exemplary embodiment of the present invention;

FIG. 5 is a flowchart illustrating a method of recognizing a three-dimension object according to a second exemplary embodiment of the present invention;

FIG. 6 is a flowchart illustrating a method of recognizing a three-dimension object according to a third exemplary embodiment of the present invention; and

FIGS. 7A through 7C are exemplary diagrams illustrating recognition of a three-dimension object according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, a method and an apparatus for recognizing a three-dimension object according to an exemplary embodiment of the present invention will be described with the accompanying drawings.

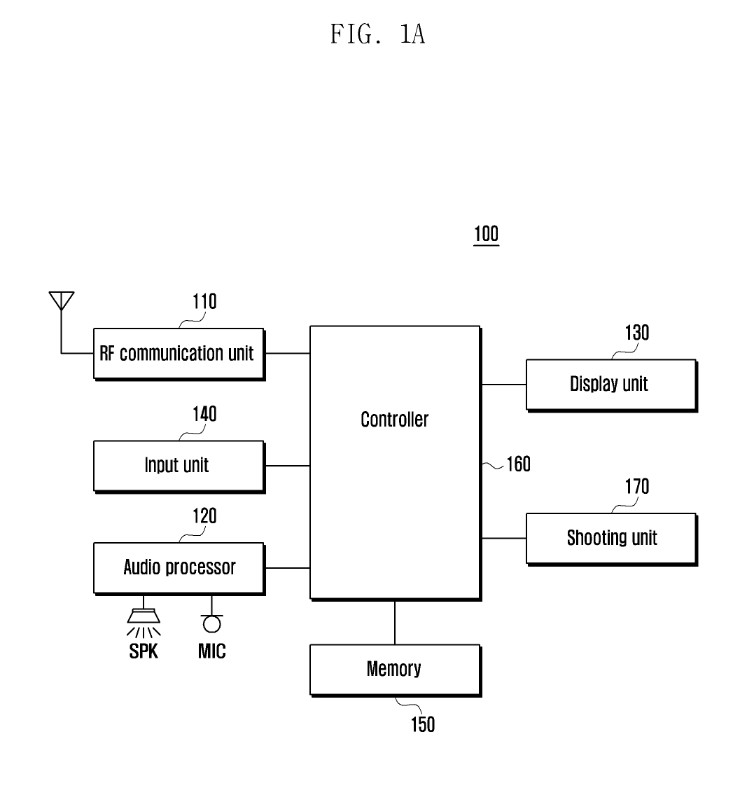

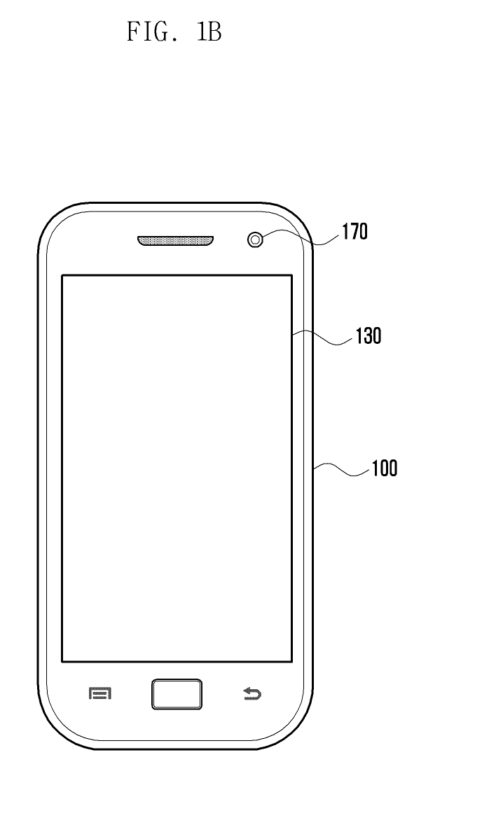

FIGS. 1A through 7C, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1A is a block diagram illustrating a configuration of an apparatus for recognizing a three-dimension object according to an exemplary embodiment of the present invention.

Referring to FIG. 1A, an apparatus 100 for recognizing a three-dimension object includes a Radio Frequency (RF) communication unit 110, an audio processor 120, a display unit 130, an input unit 140, a memory 150, a controller 160, and a shooting unit 170.

The RF communication unit 110 performs a transceiving function of corresponding data for wireless communication of the apparatus 100 for recognizing a three-dimension object. The RF communication unit 110 may include an RF transmitter for up-converting a frequency of a transmitted signal and amplifying the converted signal, and an RF receiver for low-noise-amplifying a received signal and down-converting the amplified signal. The RF communication unit 110 receives and outputs data through a wireless channel to the controller 160 and transmits data outputted from the controller 160. In a case of the apparatus 100 for recognizing a three-dimension object, which does not support wireless communication, the RF communication unit 110 may be omitted.

The audio processor 120 may be configured by a COder/DECoder (CODEC). The CODEC may include a data CODEC processing packet data and an audio CODEC processing an audio signal, such as a voice. The audio processor 120 converts a digital audio signal into an analog audio signal through the audio CODEC and plays the converted analog audio signal through a speaker SPK. The audio processor 120 converts an analog audio signal inputted from a microphone MIC into a digital audio signal. In a case of the apparatus 100 for recognizing a three-dimension object, which does not support audio processing, the audio processor 120 may be omitted.

The input unit 140 receives an input of the user and transfers the input of the user to the controller 160. The input unit 140 may be implemented in the form of a touch sensor and/or a key pad.

The touch sensor detects a touch input of the user. The touch sensor may be configured by a capacitive overlay sensor, a resistive overlay sensor, an infrared beam sensor, or a pressure sensor. Various types of sensor devices capable of detecting contact or pressure of an object may be configured as a touch sensor in addition to the foregoing sensors. The touch sensor detects a touch input of the user and generates and transmits a detection signal to the controller 160. The detection signal includes coordinates data which the user inputs the touch. When the user inputs a touch location moving operation, the touch sensor generates the detection signal including coordinates data of a touch location moving path to the controller 160.

The key pad receives a key operation of the user for controlling the apparatus 100 for recognizing a three-dimension object and generates and transfers an input signal to the controller 160. The key pad may include numeric keys and arrow keys. The key pad may be provided in one side of the apparatus 100 for recognizing a three-dimension object as a predefined function key.

The display unit 130 visually provides a menu of the apparatus 100 for recognizing a three-dimension object, input data, function setting information and other various information to the user. The display unit 130 performs a function of outputting a booting screen, an idle screen, a menu screen, a call screen, and other application screens. The display unit 110 may be configured by a Liquid Crystal Display (LCD), an Organic Light Emitting Diode (OLED), an Active Matrix Organic Light Emitting Diode (AMOLED), and the like. The display unit 130 performs a function of outputting a booting screen, an idle screen, a menu screen, a call screen, and other application screens of the apparatus 100 for recognizing a three-dimension object.

Furthermore, the display unit 130 converts brightness of a screen into at least two brightness and provides the at least two brightness when performing an object recognition function for releasing the lock screen. If receiving an object image corresponding to at least two screen brightness, the shooting unit 170 may compare respective object images to recognize the objects.

The memory 150 stores programs and data used for an operation of the apparatus 100 for recognizing a three-dimension object. The memory 130 may be divided into a program area and a data area. The program area may store a program controlling an overall operation of the apparatus 100 for recognizing a three-dimension object, an operating system booting the apparatus 100 for recognizing a three-dimension object, an application program used for playing multi-media contents, and an application program used for other option functions of the apparatus 100 for recognizing a three-dimension object, for example, a camera function, a sound playback function, and an image or moving image playback function. The data area may store data generated according to use of the apparatus 100 for recognizing a three-dimension object, images, moving pictures, phone-books, audio data, and the like.

More particularly, the memory 150 may store an object (e.g., a face) image for a lock function according to setting of the user or information obtained by processing the object image.

The shooting unit 170 shoots an image under the control of the controller 160. The shooting unit 170 has the same operation scheme or configuration as those of the related art, and thus the description thereof is appropriately omitted.

FIG. 1B is a front view of an apparatus for recognizing a three-dimension object according to an exemplary embodiment of the present invention.

Referring to FIG. 1B, a screen of the display unit 130 and a camera of the shooing unit 170 have to orient toward the same direction. For example, the screen of the display unit 130 and a lens of the shooting unit 170 should be disposed so that light emitted from the shooting unit 170 reaches an object for shooting and is again reflected from the shooting unit 170.

Referring back to FIG. 1A, the controller 160 controls an overall operation of respective constituent elements of the apparatus 100 for recognizing a three-dimension object.

More particularly, when receiving a lock function setting command, the controller 160 shoots a first image by setting a first brightness to the display unit 130, and shoots a second image by again setting a second brightness different from the first brightness to the display unit 130. Thereafter, if the apparatus 100 for recognizing a three-dimension object enters the lock state and receives a command for lock release, the controller 160 shoots a third image by setting third brightness to the display unit 130, and shoots a fourth image by again setting the second brightness different from the third brightness to the display unit 130. In the exemplary embodiment of the present invention, the third brightness may be the same as or differ from the first brightness. In the same manner, the fourth brightness may be the same as or differ from the second brightness. The controller 160 compares the second image with the first image, and compares the fourth image with the third image. The controller 160 may recognize a three-dimension object based on the comparison results. In another exemplary embodiment of the present invention, the controller 160 may control the shooting unit 170 to repeatedly shoot while increasing brightness of the display unit 130 from the third brightness to a limited brightness at preset speed or lower. According to another exemplary embodiment of the present invention, the controller 160 may detect a direction of the object from the image and convert the image according thereto to recognize the three-dimension object.

Concrete operations of respective constituent elements shown in FIG. 1 will be described with reference to following drawings.

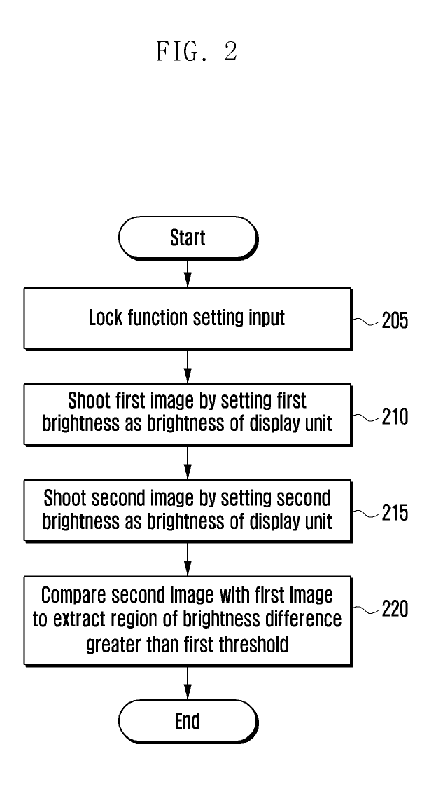

FIG. 2 is a flowchart illustrating a method of setting a lock function using a three-dimension object recognition according to a first exemplary embodiment of the present invention.

Referring to FIG. 2, the input unit 140 receives an input for commanding a lock function setting start from the user in step 205. The user may command the lock function setting through a menu or other schemes. If receiving the input for commanding the lock function setting, the controller 160 may perform a procedure of setting a lock function as illustrated in steps 210 and 215.

The controller 160 may shoot the first image by setting a first brightness as a brightness of the display unit 130 in step 210. The controller 160 may shoot the second image by setting a second brightness as the brightness of the display unit 130 in step 215. The second brightness should differ from the first brightness. The following exemplary embodiment of the present invention will be described on the assumption that the second brightness is brighter than the first brightness.

The controller 160 compares the second image with the first image to extract a region (i.e., an interest region) having a brightness difference greater than a first threshold (i.e., a threshold of an interest region) in step 220. The first threshold may be a preset value. According to another exemplary embodiment of the present invention, the first threshold may be set such that a predefined part of an entire region becomes the interest region according to a brightness difference distribution in a comparison result of an entire image. For example, to set the interest region to be 10% of an entire region, if there is 10% of the entire region having a brightness difference greater than A, the threshold is A.

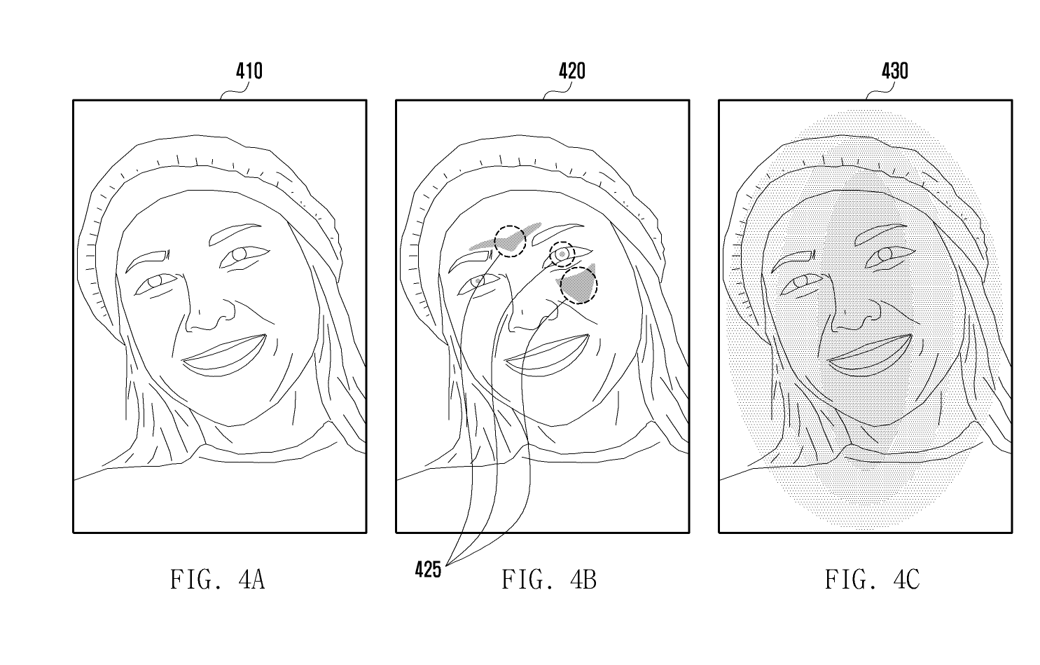

FIGS. 4A through 4C are exemplary diagrams illustrating a shot image of a shooting unit according to a first exemplary embodiment of the present invention.

Referring to FIGS. 4A through 4C, a first image 410 is an image shooting a three-dimension object, for example, a human face by setting a relatively dark brightness (i.e., a first brightness). A second image 420 is an image shooting the human face by setting a brightness (i.e., a second brightness) brighter than that of the first image. A third image 430 is an image again shooting a two-dimension photograph outputting the human face by the shooting unit 170 by setting the third brightness to the display unit 130.

Since the human face is the three-dimension object, if the display unit 130 emits a strong light, the human face may reflect more light from the display unit 130 as compared with a protruding part, such as a forehead, eyes, cheekbone regions 425, parts having special materials, or the like. Greater brightness change on the regions 425 is observed as compared with other regions. However, the two-dimension photograph relatively uniformly reflects light of the display unit 130. There is no brightness change in an image 430 again shooting the two-dimension photograph except that a central part of a photograph relatively adjacent to a center of the display unit 130 shines brightly.

Accordingly, if the shooting unit 170 shoots an actual three-dimension object, such as a human face in steps 210 and 215, a region 425 having great brightness change may be extracted according to a stereoscopic characteristic or a material characteristic. Hereinafter, the region is referred to as an ‘interest region’.

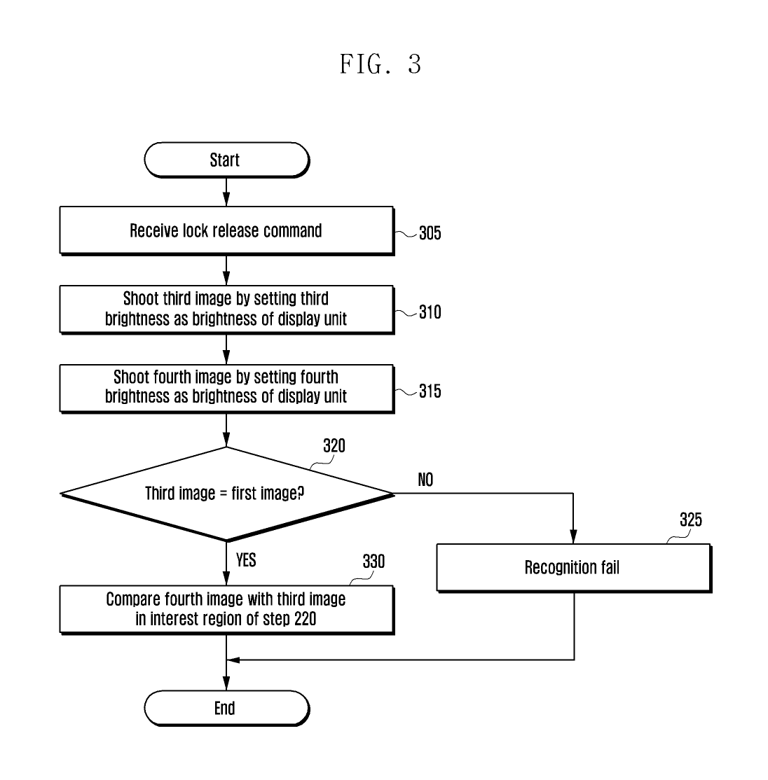

If a lock setting procedure of FIG. 2 is terminated, a lock release operation may be performed in a scheme of FIG. 3.

FIG. 3 is a flowchart illustrating a method of recognizing a three-dimension object according to a first exemplary embodiment of the present invention.

Referring to FIG. 3, the controller 160 receives a lock release command in step 305. For example, when the apparatus 100 for recognizing a three-dimension object is switched from a sleep mode to an active mode or power of the apparatus 100 for recognizing a three-dimension object is turned-off and turned-on, the controller 160 may receive the lock release command. When receiving a command for performing an operation requiring other security, for example, initialization or a function, such as private information reading included in the apparatus, the controller 160 may receive the lock release command When receiving the lock release command, the controller 160 may perform steps 310 and next steps. Although the lock release procedure is illustrated, steps 310 and next steps may be performed for an operation requiring other face recognition or object recognition.

The controller 160 may shoot a third image by setting a third brightness as brightness of the display unit 130 in step 310. The controller 160 may shoot a fourth image by setting a fourth brightness as brightness of the display unit 130 in step 315. It is assumed that the third brightness is the same as the first brightness. However, in another exemplary embodiment of the present invention, the third brightness may differ from the first brightness. It is assumed that the fourth brightness is the same as the second brightness. However, in another exemplary embodiment of the present invention, the fourth brightness may differ from the second brightness.

An image displayed on the display unit 130 at steps 310 and 315 may be an image in which a full screen is similar to white. Accordingly, radiating effect of light through the display unit 130 may be maximized. According to a modified exemplary embodiment of the present invention, an image displayed through the display unit 130 may be set according to a selection input of the user. A procedure of setting an image displayed through the display unit 130 may be performed in addition to a setting procedure of FIG. 2.

The controller 160 determines whether the third image is the same as, that is, accords with the first image in step 320. Determination of the identity of the image does not determine whether the third image is physically the same as the first image but an object of the third image is substantially the same as the first image. For example, if the third image accords with the first image by suitably correcting or converting the first image and the third image, the controller 160 determines that the third image is the same as the first image. Although the foregoing exemplary embodiment of the present invention has illustrated that the third image is compared with the first image, the fourth image may be compared with the second image, the third image is compared with the second image, or the fourth image may be compared with the first image.

When the third image differs from the first image, the controller 160 determines that three-dimension object recognition fails in step 325. For example, the controller 160 determines that a lock release attempt performed through steps 310 and 315 is a lock release attempt of a user which is not authenticated, and maintains a lock state. When the third image differs from the first image, the process goes to step 330.

The controller 160 compares the fourth image with the third image in the region extracted at step 220, that is, an interest region in step 330. As the comparison result of the third and fourth images, when a brightness difference of the interest region is equal to or greater than a second preset threshold (recognition threshold), the controller 160 determines that a currently shot object is the same as an object set in the procedure of FIG. 2. As the comparison result of the third and fourth images, when a brightness difference of the interest region is equal to or greater than a second preset threshold (i.e., a recognition threshold), the controller 160 determines that a currently shot object differs from the object set in the procedure of FIG. 2. The second preset threshold (i.e., the recognition threshold) may be less than the first threshold (i.e., a threshold of interest region) of FIG. 2. If the second threshold is very large, it may not be determined that a shot object is the same as a preset object. If the second threshold is very small, a case of shooting a two-dimension photograph may not be filtered. Accordingly, the second threshold may be slightly smaller than the first threshold. A concrete threshold may be experimentally determined so that erroneous recognition is minimized.

According to another exemplary embodiment, when parts except for the interest region have a brightness difference greater than a third threshold, the controller 160 may perform a step of determining that object recognition fails regardless of step 330. An artificial illumination is applied to increase the brightness difference greater than a predefined value to prevent a security function from being incapacitated.

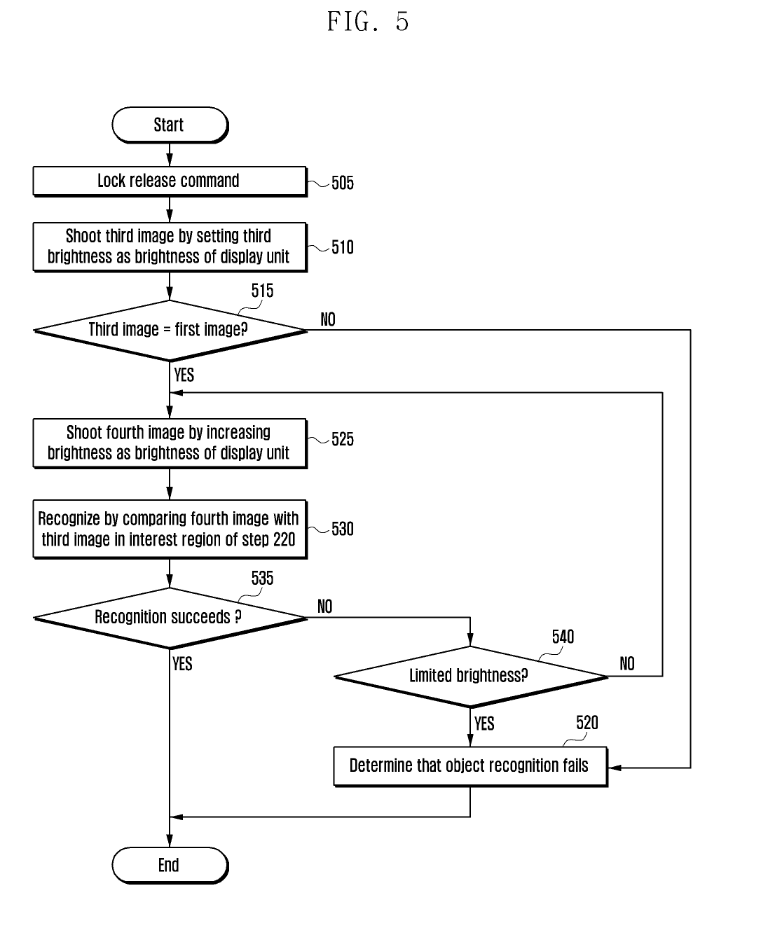

FIG. 5 is a flowchart illustrating a method of recognizing a three-dimension object according to a second exemplary embodiment of the present invention. It is assumed that a lock function is set according to a procedure of FIG. 2 in the second exemplary embodiment of the present invention.

Referring to FIG. 5, the controller 160 receives a command starting a lock release operation in step 505. Thereafter, the controller 160 shoots a third image by setting a third brightness as a brightness of the display unit 130 in step 510. The third brightness may be the same value as that of the first brightness. The controller 160 determines whether the third image is the same as the first image in step 515. Since a determination procedure of the identity of the image is similar to a procedure of step 320, a description thereof is omitted. When the third image differs from the first image, the controller 160 determines that the object recognition fails in step 520. For example, the lock state is not released. When the third image is the same as the first image, the process goes to step 525.

The controller 160 shoots a fourth image by increasing brightness of the display unit 130 by a predefined amount in step 525. In this case, the increased brightness of the display unit 130 is limited to less than a preset value. When a screen of the display unit 130 becomes bright at an excessively high speed, the user may show an action, for example, momentarily feel discomfort, make a wry face, close their eyes, or the like. Accordingly, it is not desired to make the display unit 130 bright at an excessively high speed.

The controller 160 recognizes the object by comparing the fourth image with the third image in the interest region at step 220 in step 530. The object recognition procedure of step 530 is the same/similar as step 330 of FIG. 3, and thus the description thereof is appropriately omitted.

The controller 160 determines whether object recognition succeeds in step 535. When the object recognition succeeds, a lock state is released and the process is terminated. When the object recognition does not succeed, the process goes to step 540. The controller 160 determines whether the brightness of the display unit 130 reaches a preset limited brightness, that is, is equal to or greater than the limited brightness in step 540. When the brightness of the display unit 130 reaches the limited brightness, the controller 160 determines that the object recognition fails in step 520. Accordingly, the lock state is not released. When the brightness of the display unit 130 does not reach the limited brightness, the process returns to step 525. When the object recognition succeeds or until the brightness of the display unit 130 reaches the limited brightness, steps 525 through 540 may be repeatedly performed.

According to the scheme of FIG. 5, face recognition may be efficiently performed while reducing discomfort of the user in a scheme of repeating shooting by slowly increasing the brightness of the display unit 130.

According to a modified exemplary embodiment of the scheme in FIG. 5, the apparatus 100 for recognizing a three-dimension object may include an illumination sensor. When receiving a lock release command of step 505, the controller 160 may set a start brightness of the display unit 130 according to a peripheral illumination value measured by the illumination sensor. For example, when the peripheral illumination is relatively bright, the start brightness of the display unit 130 may be set brighter. Conversely, when the peripheral illumination is relatively dark, the start brightness of the display unit 130 may be set darker. Thereafter, the controller 160 may shoot a third image when the brightness of the display unit 130 reaches the third brightness of step 510 while slowly increasing the brightness of the display unit 130, and perform following operations.

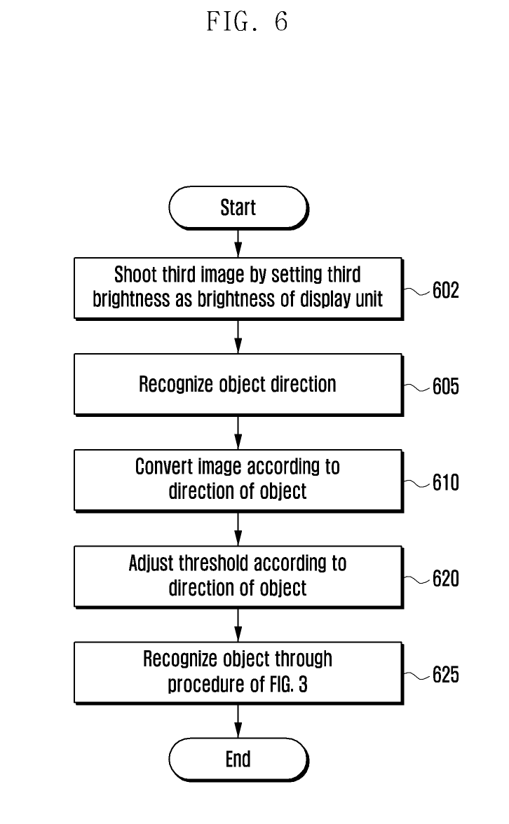

FIG. 6 is a flowchart illustrating a method of recognizing a three-dimension object according to a third exemplary embodiment of the present invention.

Referring to FIG. 6, the controller 160 shoots a third image by setting a third brightness as a brightness of a display unit 130 in step 602. Step 602 is the same as step 310 of FIG. 3, and thus the description thereof is appropriately omitted.

The controller 160 recognizes a direction of an object based on the third image in step 605. The remaining steps of FIG. 6 are described below.

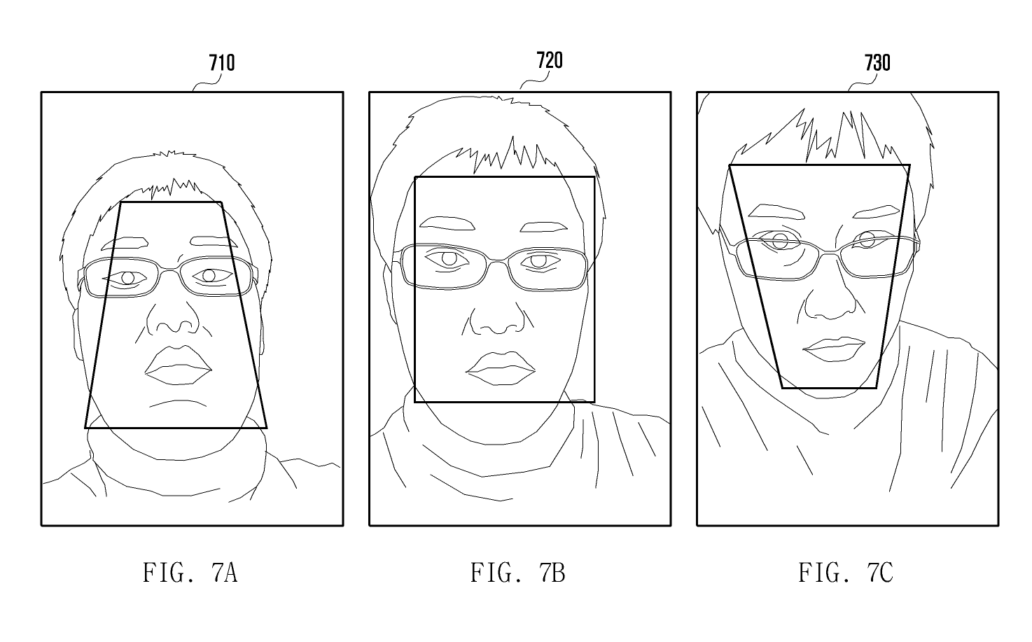

FIGS. 7A through 7C are exemplary diagrams illustrating recognition of a three-dimension object according to exemplary embodiments of the present invention.

Referring to FIGS. 7A through 7C, a first screen 710 is an image shooting a face from the bottom. A second screen 720 is an image shooting a face from a front side. A third screen 730 is an image shooting a face from the top. As the object is located away from the shooting unit 170, the object is shot smaller, and accordingly a whole shape of the face is differently expressed. An upper portion and a lower portion of the face in the first screen 710 are shown smaller and larger as the second screen 720. A lower portion and an upper portion of the face in the third screen 730 are shown smaller and larger as the second screen 720. Accordingly, if an object direction is normally recognized, erroneous recognition may be prevented.

To recognize the direction of the object, various schemes may be performed independently. For example, the apparatus 100 for recognizing a three-dimension object may include at least one of a geomagnetic sensor/acceleration sensor/gyro sensor. In this case, the controller 160 may determine a direction of the apparatus 100 for recognizing a three-dimension object using the geomagnetic sensor/acceleration sensor/gyro sensor. When recognizing the direction of the apparatus 100 for recognizing a three-dimension object, the apparatus 100 may recognize a relative direction of the face and other objects using the direction of the apparatus 100.

According to another exemplary embodiment of the present invention, the apparatus 100 for recognizing a three-dimension object may recognize a direction of an object using disposal of a characteristic part of a three-dimension object indicated on the third image. For example, in a case of a face image, a direction of the object may be determined based on a disposed form of a characteristic part, such as eyes or a mouth. As a result of determining a ratio of a distance between eyes and a size of a mouth in the third image, when the distance between the eyes is less than a suitable ratio, the controller 160 may determine that the object is shot from the bottom. A direction of the object may be recognized through a disposal of a characteristic part of the face. The direction of the object may be recognized using information of the geomagnetic sensor/acceleration sensor/gyro sensor and disposal of a characteristic part in a shot image.

Referring back to FIG. 6, the controller 160 converts an image according to the recognized direction of the object in step 610. For example, when it is recognized that the object is shot from the bottom, image correction may be performed according to a perspective in such a way that a size of a lower part is converted small and the size of the upper part is converted large.

The controller 160 adjusts a threshold for recognition of the object according to a direction of an object in step 620. Referring to FIG. 3, when a brightness difference of an interest region is equal to or greater than a recognition threshold, the controller 160 determines that a shot object is the same as a preset object. However, since the brightness difference may be changed according to a shot direction, the controller 160 reflects this. For example, when the face is shot from the bottom in step 710, the controller 160 may control a recognition threshold of an interest region corresponding to a forehead located in an upper side of the face or eyes smaller. This is why the forehead and eyes cannot normally receive and reflect light of the display unit 130 because the forehead and eyes are distant from the display unit 130. Conversely, when the face is shot from the top in step 730, the controller 160 may control a recognition threshold of an interest region corresponding to a forehead located in an upper side of the face or eyes larger. This is why the forehead and eyes cannot receive and reflect light of the display unit 130 because the forehead and eyes are near to the display unit 130.

The controller 160 recognizes the object through the procedure of FIG. 3 in step 625. The fourth image of step 315 may be converted in an object recognition procedure in the same manner in the third image. The procedure of FIG. 3 is equally applicable except for an image conversion according to the direction of the object and control of the threshold. A procedure of FIG. 5 is applicable instead of the procedure of FIG. 3.

According to the scheme of FIGS. 6 and 7A through 7C, even if the user does not turn or bend a face unnaturally, the face is exactly recognized so that a face recognition function may be conveniently used.

Here, it will be appreciated that combinations of process flowcharts and respective blocks thereof may be achieved by instructions of a computer program. Because instructions of a computer program may be mounted in a processor of a general-purpose computer, a special computer, programmable data processing equipment, or the like, they generate means for executing functions described in flowchart block(s). Because the instructions of a computer program may be stored in a computer usable or readable memory of a computer or a programmable data processing equipment to implement a function in a specific way, they may produce manufacturing goods including instruction means for executing functions described in flowchart block(s). Because the instructions of a computer program may be mounted in a computer or a programmable data processing equipment, a series of operation stages are executed on the computer or the programmable data processing equipment to produce a process executed by the computer such that the instructions executing the computer or the programmable data processing equipment may provide stages for executing functions described in flowchart block(s).

Furthermore, each block may indicate a part of a module including at least one executable instruction for executing specific logical function(s), a segment, and a code. In substitute execution exemplary embodiments, it should be noticed that functions mentioned in blocks may be created beyond an order. Two sequentially shown blocks may be performed simultaneously or in a reverse order according to a corresponding function. As used in this exemplary embodiment, the term “unit” means software, or a hardware structural element, such as a Field Programmable Gate Array (FPGA) or an Application Specific Integrated Circuit (ASIC), and performs some functions. However, “unit” is not limited to software or hardware. A “unit” may be configured in an addressable storing medium to play at least one processor. Accordingly, for example, “unit” includes software structural elements, object-oriented software structural elements, class structural elements, task structural elements, processes, functions, attributes, procedures, sub-routines, segments of a program code, drivers, firmware, micro code, circuit, data, database, data structures, tables, arrays, variables, and the like. Functions provided to structural elements and units may be combined by a smaller number of structural elements and units or divided into additional structural elements and units. In addition, structural elements and units may be implemented to play at least one Central Processing Unit (CPU) in a device or a security multimedia card.

The exemplary embodiment of the present invention represents an effect which may provide an apparatus and a method for recognizing a three-dimension object and preventing a security function from being incapacitated when using a two-dimension photograph.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of recognizing a three-dimension object of a terminal including a display unit for displaying an operation state of the terminal and a shoot unit for receiving an image, the method comprising:
receiving a first image by setting a first brightness as a brightness of the display unit;
receiving a second image by setting a second brightness as the brightness of the display unit; and
recognizing the three-dimension object based on brightness change of a preset part by comparing the second image with the first image.

2. The method of claim 1, wherein the receiving of the second image comprises:
repeatedly receiving the second image while increasing the brightness of the display unit from the first brightness to a limited brightness at a speed less than a preset value.

3. The method of claim 1, wherein the recognizing of the three-dimension object comprises:
recognizing the three-dimension object based on the brightness change of the preset part by comparing the second image with the first image while the brightness of the display unit is increased.

4. The method of claim 1, wherein the recognizing of the three-dimension object comprises:
detecting a direction of an object in the first image;
converting at least one of the first image and a comparison target image according to the recognized direction of the object; and
at least one of comparing the converted comparison target image with the first image and comparing the comparison target image with the first converted image.

5. The method of claim 4, further comprising:
receiving a third image by setting the second brightness as the brightness of the display unit;
receiving a fourth image by setting a fourth brightness as the brightness of the display unit; and
extracting brightness change of each region of an image by comparing the fourth image with the third image before the receiving of the first image,
wherein the recognizing of the three-dimension object comprises:
comparing the third image with the first image; and
recognizing the three-dimension object by comparing brightness change of each region of the third image and the fourth image with brightness change of each region of the first image and the second image when the third image is a same as the first image.

6. The method of claim 5, wherein the recognizing of the three-dimension object comprises:
extracting an interest region having brightness change equal to or greater than a first threshold as a comparison result of the third image and the fourth image; and
recognizing that an object of the third image differs from an object of the first image when the brightness change of the interest region is less than a second threshold as a comparison result of the first image and the second image.

7. The method of claim 6, wherein the recognizing comprises:
controlling the second threshold with respect to an interest region being relatively farther away from a direction of an object of the first image as compared with a direction of an object of the third image according to the recognized direction of the object.

8. An apparatus for recognizing a three-dimension object, the apparatus comprising:
a display unit for displaying an operation state of a terminal;
a shooting unit for receiving an image;
a controller for controlling the shooting unit to receive a first image by setting a first brightness as a brightness of the display unit, for controlling the shooting unit to receive a second image by setting a second brightness as the brightness of the display unit, and for recognizing the three-dimension object based on brightness change of a preset part by comparing the second image with the first image.

9. The apparatus of claim 8, wherein the controller controls the shooting unit to repeatedly receive the second image while increasing the brightness of the display unit from the first brightness to a limited brightness at a speed less than a preset value.

10. The apparatus of claim 8, wherein the controller controls the shooting unit to recognize the three-dimension object based on the brightness change of the preset part by comparing the second image with the first image while the brightness of the display unit is increased.

11. The apparatus of claim 8, wherein the controller detects a direction of an object in the first image, converts at least one of the first image and a comparison target image according to the recognized direction of the object, and compares the converted comparison target image with the first image or compares the comparison target image with the first converted image.

12. The apparatus of claim 11, wherein the controller controls the shooting unit to receive a third image by setting the second brightness as the brightness of the display unit, controls the shooting unit to receive a fourth image by setting a fourth brightness as the brightness of the display unit, extracts brightness change of each region of an image by comparing the fourth image with the third image before the receiving of the first image, compares the third image with the first image, and recognizes the three-dimension object by comparing brightness change of each region of the third image and the fourth image with brightness change of each region of the first image and the second image when the third image is a same as the first image.

13. The apparatus of claim 12, wherein the controller extracts an interest region having brightness change equal to or greater than a first threshold as a comparison result of the third image and the fourth image, and recognizes that an object of the third image differs from an object of the first image when the brightness change of the interest region is less than a second threshold as a comparison result of the first image and the second image.

14. The apparatus of claim 13, wherein the controller controls the second threshold with respect to an interest region being relatively farther away from a direction of an object of the first image as compared with a direction of an object of the third image according to the recognized direction of the object.
